(19) United States
(12) Patent Application Publication
(10) Pub. No.: US 2003/0142984 A1
(43) Pub. Date: Jul. 31, 2003

(54) Optical communication circuit chip, optical/electrical common transmission apparatus, optical transmission apparatus, and electric apparatus using same

(76) Inventors: Yoshifumi Masuda, Kashihara-shi (JP); Takayuki Shimizu, Osaka (JP); Yasukazu Kuwamura, Kashihara-shi (JP)

Correspondence Address: BIRCH STEWART KOLASCH & BIRCH, PO BOX 747, FALLS CHURCH, VA, 22040-0747, US

(21) Appl. No.: 10/338,723

(22) Filed: Jan. 9, 2003

(30) Foreign Application Priority Data
Jan. 25, 2002 (JP) 2002-017626
Jan. 25, 2002 (JP) 2002-017638

(51) Int. Cl. H04B 10/02

(52) U.S. Cl. 398/115; 398/15; 398/182

(57) ABSTRACT

In an optical receiver circuit chip, which constitutes an optical fiber link and converts a received optical signal into an electrical signal for communication, shutdown function is added to a bias circuit, which supplies power to an internal circuit such as a photodiode, amplifiers, a comparator and a buffer. Furthermore, a shutdown control circuit is provided in order to cause the bias circuit to perform a shutdown control in response to whether or not a plug for a transmission medium such as an optical fiber is inserted to a corresponding jack and in response to an shutdown signal inputted to a shutdown input terminal in accordance with user's operation. Therefore, the shutdown control can be realized with lower cost and smaller substrate space compared with a case where a regulator IC is separately used.

### FIELD OF THE INVENTION

The present invention relates to an optical communication circuit chip, an optical/electrical common transmission apparatus, and an optical transmission apparatus, which are used in order to form an optical fiber link for converting an electrical signal into an optical digital signal and transmitting the signal, and an electronic apparatus using the same.

### BACKGROUND OF THE INVENTION

An optical fiber link has become more and more popular these days among households as a digital device having an optical transmitter-receiver circuit has come into wide use. The optical fiber link easily attains a high speed transmission of multi-channel signals such as an audio signal, a picture signal and the like via a single optical fiber by converting an electrical signal into an optical signal at a transmitter side and by converting back the optical signal into an electrical signal at a receiver side. The optical fiber link is used, for example, in signal transmission from (a) a DVD (Digital Video Disk) player, STBs (Setup Box) for digital broadcasting and CD (Compact Disk) players, to (b) MD (Mini Disk) players, amplifiers and the like. It has also become popular to transmit a music signal to personal portable devices such as personal computers. Moreover, the optical fiber link is used in transmitting a signal through an area where electric insulation is necessary.

FIG. 19 is a cross-sectional view showing an arrangement of an optical/electrical common transmission apparatus 70, which is a typical prior art. The optical/electrical common transmission apparatus 70 is disclosed in Japanese publication of unexamined patent application NO. 6-140106, Tokukaihei, (Date of Publication: May 20, 1994). Schematically, the optical/electrical common transmission apparatus 70 includes an optical semiconductor element 71, a plurality of electric contact terminals 72, and a supporting body 73. The optical semiconductor element 71 transmits and receives an optical signal when optical fiber is used as a transmission medium. When electric cable is used as a transmission medium, the electric connection terminals 72 touch a single-head type small electrical plug for electricity transmission connected to an end of the electric cable, and transmit and receive an electrical signal. The supporting body 73 contains and supports the optical semiconductor element 71 and the electric contact terminals 72. On an outer circumference surface of the supporting body 73, an external connecter 74 is located to connect, to an external circuit, the optical semiconductor element 71 and/or the electric contact terminals 72.

The optical/electrical common transmission apparatus 70 can perform both transmission of an optical signal and transmission of an electrical signal by, as indicated by reference numeral 76, selectively inserting an electrical plug or an optical fiber plug having a similar shape to that of the electrical plug into a common inserting slot 75, which is one end surface of the tube-shaped supporting body 73, so that a constriction of a single-head section of either the electrical plug or the optical fiber plug is fitted together with a corresponding area of the common inserting slot 75.

Among the plugs to be inserted into the inserting slot 75, the optical fiber plug has an inserting section shorter than a depth of the inserting slot and longer than an inserting section of the electronic plug. Because of this, an end surface of the single-head section of the optical fiber plug comes close to the optical semiconductor element 71 when the optical fiber plug is inserted into the inserting slot 75. Moreover, although not shown in FIG. 19, also provided are a means for detecting whether a plug 76 inserted in the inserting slot 75 of the supporting body 73 is a plug for the optical signal or a plug for the electrical signal, and a means for detecting whether or not a plug 76 is inserted in the inserting slot 75.

FIG. 20 is a cross-sectional view showing an arrangement of an optical/electrical common transmission apparatus 80, which is another prior art. The optical/electrical common transmission apparatus 80 is disclosed in Japanese publication of unexamined patent application NO. 6-111876, Tokukaihei, (Date of Publication: Apr. 22, 1994). Like the optical/electrical common transmission apparatus 70, the optical/electrical common transmission apparatus 80 includes a connection terminal 81, an optical element 82, and a supporting body 83. The connection terminal 81 receives and transmits an electrical signal by touching an inserted plug for electrical signal. The optical element 82, which faces a signal transmitter-receiver surface formed at an edge surface of an inserted plug for optical signal, receives and transmits an optical signal. The supporting body 83 integrally contains the contact terminal 81 and the optical element 82.

Apart from these publications, the following publications disclose prior art based on the same basic technique: Japanese publication of unexamined patent application NO. 2000-285996, Tokukai, (Date of Publication: Oct. 13, 2000) and NO. 11-109189, Tokukaihei, (Date of Publication: Apr. 23, 1999), Japanese publication of laid-open utility model application NO. 62-193208, Jitsukaisho, (Date of Publication: Dec. 8, 1987), Japanese publication of unexamined patent application NO. 57-198419, Tokukaisho, (Date of Publication: Dec. 6, 1982) and NO. 56-17645, Tokukaisho, (Date of Publication: Feb. 19, 1981), and Japanese publication of laid-open utility model application NO. 61-53706, Jitsukaisho, (Date of Publication: Apr. 11, 1986) and NO. 1-12387, Jitsukaihei, (Date of Publication: Jan. 23, 1989). The Japanese publication of unexamined patent application NO. 6-140106, Tokukaihei, shows an example of an optical transmission apparatus using square-shaped plug and jack. Japanese publication of unexamined patent application NO. 58-111008, Tokukaisho, (Date of Publication: Jul. 1, 1983) shows a complex cord and a corresponding plug and jack, the complex cord containing an optical fiber and an electric supply line, which supply power to a transmitter-receiver module of the optical fiber.

In all above-mentioned prior arts, however, the optical semiconductor element is supplied with power when power is applied to an apparatus. The optical semiconductor element is supplied with power when an electrical plug is inserted, and even when neither an electrical plug nor an optical plug is inserted. In the Japanese publication of unexamined patent application NO. 58-111008, Tokukaisho, although power is not supplied when the complex cord is not connected, the transmitter-receiver module always supplies power to the complex plug in addition to the transmitter-receiver module itself.

These days, on the other hand, the transmitter-receiver module including the jack and a transmitter-receiver circuit has become so small that the transmitter-receiver module is loaded on portable devices. In such portable devices, reduction of electric power consumption, which determines driving time of a buttery, is strongly desired. Thus, unnecessary electric power consumption by the optical semiconductor element becomes a problem. To perform shutdown control for blocking power supply to the optical semiconductor element, it is necessary to add an external circuit such as a regulator. This is problematic because adding an external circuit involves increase in the number of components and assembly process, costs, and substrate space.

Furthermore, where power is supplied when a plug is not inserted, there is a problem that leakage light enters user's eyes and causes harmful effects on the user's eyes.

The following more specifically describes the arrangement where an external circuit such as a regulator is added. As shown in FIG. 21, a regulator IC2 having shutdown function is provided between a power source (not shown) and an optical communication circuit 1. The regulator IC2 controls whether or not to output a line voltage Vcc from a power output terminal P3 to the optical communication circuit 1, in response to a shutdown signal inputted to a shutdown input terminal P1. The line voltage Vcc is inputted from the power source (not shown) to a power input terminal P2.

Hereby electric power saving is realized by shutting down an output from the regulator IC2 by inputting the shutdown signal to the shutdown input terminal P1 when operation of the optical communication circuit 1 is not necessary.

If the regulator IC2 for exclusive use is provided, however, the regulator IC2 occupies the substrate space, thereby giving disadvantages to downsizing and cost saving.

### SUMMARY OF THE INVENTION

An object of the present invention is, in realizing shutdown control for reducing electric power consumption, to provide an optical communication circuit chip that reduces substrate space and costs, an optical/electrical common transmission apparatus and an optical transmission apparatus capable of reducing electric power consumption while preventing increase in a chip area of a circuit section, and an electric apparatus using the same.

To achieve the object, an optical communication circuit chip of the present invention for converting an electrical signal into an optical signal, and communicating by using the optical signal, includes a shutdown circuit for blocking power supply to an internal circuit in response to a shutdown signal that is inputted externally.

According to the arrangement above, in the optical communication circuit chip including, for example, a photo acceptance unit and a signal processing circuit for amplifying or wave shaping a signal received by the photo acceptance unit, or a light-emitting element and a driving circuit for amplifying a transmission signal and supplying the transmission signal to the light-emitting element, the shutdown circuit controls whether or not to supply power to the internal circuit such as the photo acceptance unit and the signal processing circuit in response to the shutdown signal from an external control circuit and the like, which is inputted in accordance with whether a plug for a transmission medium such as optical fiber is inserted into a corresponding jack or in accordance with user's operation and the like.

Thus, in realizing the shutdown control for low electric power consumption, the arrangement above makes it possible, by building-in the shutdown circuit into the optical communication circuit chip, to prevent increase of substrate space and costs compared with a case in which a regulator IC is separately used.

Furthermore, to achieve the object, an optical/electrical common transmission apparatus of the present invention includes (a) a circuit section having a light-electricity converting element and (b) a light-electricity common jack section, the optical/electrical common transmission apparatus being capable of transmitting an optical signal via a transmission medium for the optical signal when a plug connected to an end of the transmission medium is inserted into the light-electricity common jack section, and capable of transmitting an electrical signal via a transmission medium for the electrical signal when a plug, which has a similar shape to that of the plug for the optical signal, connected to an end of the transmission medium is inserted into the light-electricity common jack section, wherein the circuit section includes a signal processing circuit for the light-electricity converting element and shutdown circuit for blocking power to the light-electricity converting element and to the signal processing circuit in response to a shutdown signal, which is externally inputted into a shutdown terminal.

According to the arrangement above, in the optical/electrical common transmission apparatus capable of transmitting an optical signal by using, in addition to an arrangement of a transmission apparatus for electrical signal realized by so-called audio-use stereo mini plug and jack, (a) a plug and a jack similar to the stereo mini plug and jack and (b) the optical fiber as a transmission medium, wherein the shutdown circuit is further provided, within the same chip, in the circuit section which is provided with the light-electricity converting element such as a photodiode and a light-emitting diode, and a signal processing circuit for the light-electricity converting element such as a light receiver amplifier circuit and a driving circuit.

Then, according to the arrangement above, the shutdown circuit blocks power to the light-electricity converting element and the signal processing circuit in response to the shutdown signal, which is externally inputted into a shutdown terminal in accordance with whether the plug is inserted into the jack and in accordance with user's operation and the like.

Thus, the arrangement above achieves (a) the shutdown control for low electric power consumption with almost no increase in a chip area of the circuit section, as well as (b)use of the plug and jack for both the optical signal and the electrical signal.

Furthermore, to achieve the object, an optical transmission apparatus of the present invention for performing optical transmission via an optical fiber includes (a) a circuit section having a light-electricity converting element, and (b) a jack section, into which a plug, connected to an end of the optical fiber, is inserted to enable the optical transmission apparatus to perform optical transmission, wherein the circuit section further includes a signal processing circuit for the light-electricity converting element, and a shutdown circuit for blocking power to the light-electricity converting element and to the signal processing circuit in response to a shutdown signal which is externally inputted into a shutdown terminal.

According to the arrangement above, in the optical transmission apparatus capable of transmitting the optical signal using the optical fiber as a transmission medium, the shutdown circuit is further provided, within the same chip, in the circuit section which is provided with the light-electricity converting element such as a photodiode and a light-emitting diode, and a signal processing circuit for the light-electricity converting element such as a light receiver amplifier circuit and a driving circuit.

Then, according to the arrangement above, the shutdown circuit blocks power to the light-electricity converting element and to the signal processing circuit in response to the shutdown signal, which is externally inputted into a shutdown terminal in accordance with whether the plug is inserted into the jack and in accordance with user's operation and the like.

Thus, the arrangement above achieves the shutdown control for low electric power consumption with almost no increase in a chip area of the circuit section.

An electric apparatus of the present invention includes at least one of the optical/electrical common transmission apparatus, the optical transmission apparatus, and the optical communication circuit chip, thereby realizing an electric apparatus having low electricity consumption, while preventing increase in a chip area.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram showing an electrical arrangement of an optical receiver circuit, which realizes an optical/electrical common transmission apparatus or an optical transmission apparatus of an embodiment of the present invention.

FIG. 2 is a block figure specifically showing an arrangement of a bias circuit and a shutdown circuit in the optical receiver circuit shown in FIG. 1.

FIG. 3 is a plan view showing the optical/electrical common transmission apparatus of the embodiment of the present invention provided with a chip of the optical receiver circuit, shown in FIG. 1 and FIG. 2.

FIG. 4 is a cross-sectional view taken on line A-A of FIG. 3.

FIG. 5 is a front view of a module provided with the chip of the optical receiver circuit.

FIG. 6 shows how detection as to whether or not a plug is inserted and which type of a plug is inserted is carried out.

FIG. 7 shows an example in which a transmitting module is used as an example of the optical communication circuit chip.

FIG. 8 shows an example of shutdown control.

FIG. 9 shows another example of shutdown control.

FIG. 10 shows a further example of shutdown control.

FIG. 11 shows still another example of shutdown control.

FIG. 12 is a front view of the optical transmission apparatus of another embodiment of the present invention, provided with the optical receiver circuit.

FIG. 13 is a side view of FIG. 12.

FIG. 14 is a front view of the optical transmission apparatus of a further embodiment of the present invention, provided with the optical receiver circuit.

FIG. 15 is a side view of FIG. 14.

FIG. 16 is a cross-sectional view taken on line B-B of FIG. 15.

FIG. 17 is a cross-sectional view taken on line C-C of FIG. 14.

FIG. 18 is a cross-sectional view showing a state in which a plug is inserted in FIG. 16.

FIG. 19 is a cross-sectional view showing an arrangement of an optical/electrical common transmission apparatus that is a typical conventional.

FIG. 20 is a cross-sectional view showing an arrangement of an optical/electrical common transmission apparatus that is another conventional.

FIG. 21 is a block diagram showing shutdown control by an external regulator IC in a prior art.

### DESCRIPTION OF THE EMBODIMENTS

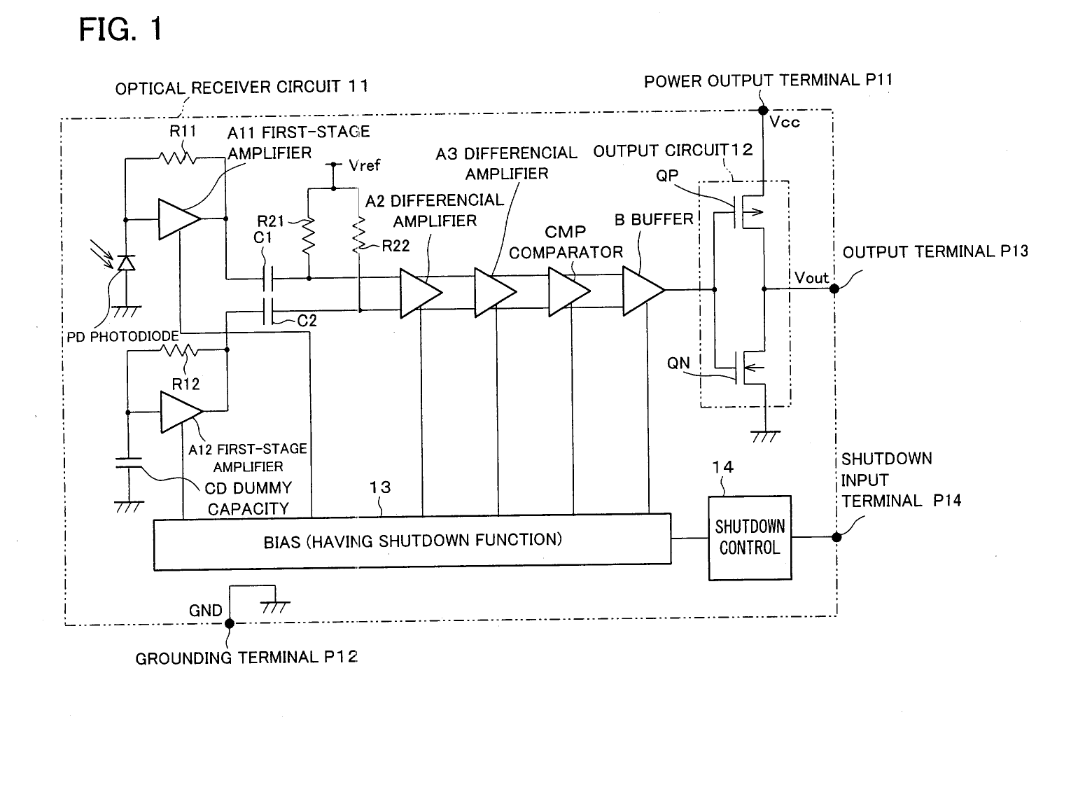

The following describes an embodiment of the present invention with reference to FIGS. 1 to 11.

FIG. 1 is a block diagram, showing an electrical arrangement of an optical receiver circuit 11, which realizes an optical/electrical common transmission apparatus or an optical transmission apparatus of the embodiment of the present invention. The optical receiver circuit 11, including a photodiode PD, is monolithically formed into a single chip. Schematically, the optical receiver circuit 11 is provided with the photodiode PD, a dummy capacity CD, first-stage amplifiers A11 and A12, differential amplifiers A2 and A3, a comparator CMP, a buffer B, an output circuit 12, a bias circuit 13 and a shutdown circuit 14.

The photodiode PD is biased by the first-stage amplifier A11 corresponding thereto. An electric current that corresponds to an optical signal received from the photodiode PD is converted into voltage by a resistance R11 of the first-stage amplifier A11 and is outputted from the first-stage amplifier A11 in low impedance. Moreover, the dummy capacitance CD is formed so as to be equal to parasitic capacity of the photodiode PD. An electric current that passes through the dummy capacity CD is converted into voltage by the first-stage amplifier A12 and resistance R12, whose arrangements are similar to those of the first-stage amplifier A11 and the resistance R12, and is outputted in low impedance.

Outputs from the first-stage amplifiers A11 and A12 are supplied to each input terminal of the differential amplifier A2, which is AC coupled by coupling capacitors C1 and C2. Each input terminal of the differential amplifier A2 also receives reference voltage Vref through pull-up resistances R21 and R22. Each input of the differential amplifier A2, therefore, has a superposed value of AC component of the outputs from the first-stage amplifiers A11 and A12, having the reference voltage Vref at a center. The differential amplifier A2 amplifies difference between the inputs, and the differential amplifier A2 outputs in a differential voltage signal. Noise from a GND potential through the photodiode PD, which appears in the input from the first-stage amplifier A11, also appears in-phase in the input from the first-stage amplifier A12. Therefore, the differential amplifier A2 outputs a signal from which the noise is removed (that is, the differential amplifier A2 outputs a signal free from noise).

A differential amplifier A3 further amplifies outputs from the differential amplifier A2. The comparator CMP compares differential voltage signals of the output and shapes the differential voltage signals into differential and rectangle signals. The buffer B transforms differential outputs from the comparator CMP into a single output, and the buffer B inputs the single output to the output circuit 12.

The output circuit 12 is a push-pull amplifier having a CMOS arrangement and is provided with a PMOS transistor QP and an NMOS transistor QN. The output circuit 12 receives, as power sources, a line voltage Vcc to be inputted to a power input terminal P11 and a GND potential supplied to a grounding terminal P12. An output Vout, which is to be supplied to an output terminal P13, inverts an output from the buffer B and becomes the power Vcc or the GND potential.

A bias circuit 13 supplies power to the first-stage amplifiers A11 and A12, the differential amplifiers A2 and A3, the comparator CMP and the buffer B. Whether or not the bias circuit 13 supplies power is controlled by the shutdown circuit 14 in response to a shutdown signal which is externally inputted to a shutdown input terminal P14.

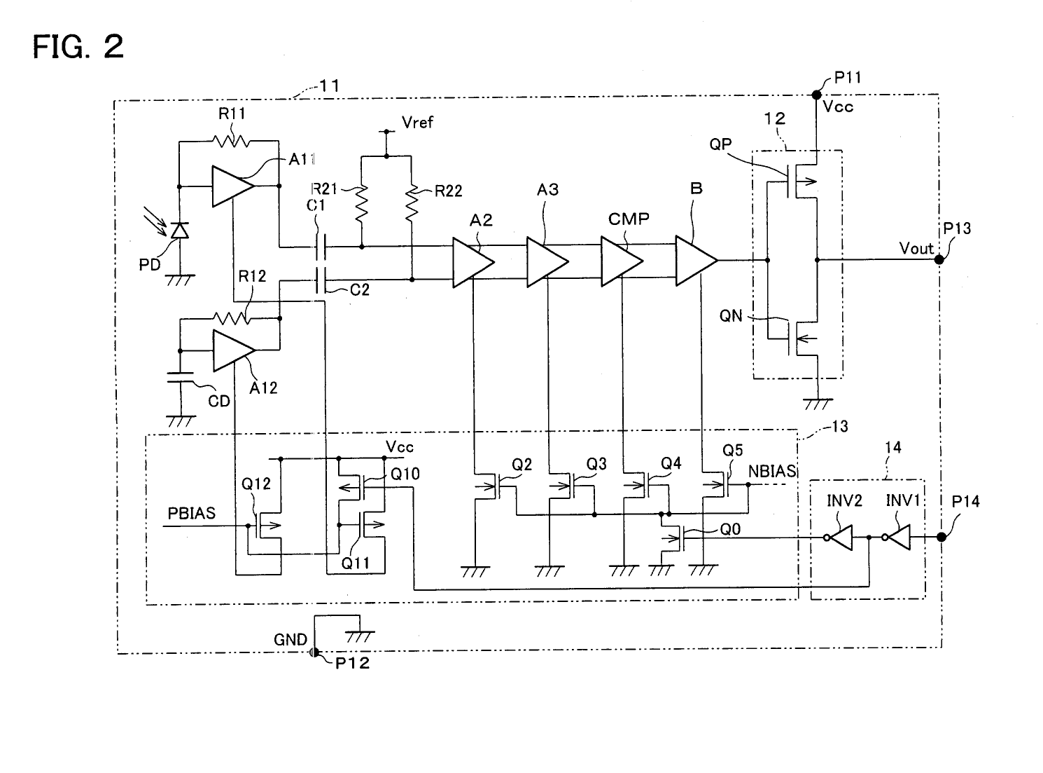

FIG. 2 is a block diagram specifically showing an arrangement of the bias circuit 13 and the shutdown circuit 14 in the optical receiver circuit 11 having above-mentioned arrangement. Sections corresponding to those in FIG. 1 are labeled in the same manner. The bias circuit 13 is provided with PMOS transistors Q11 and Q12, a PMOS transistor Q10, NMOS transistors Q2, Q3, Q4, and Q5, and an NMOS transistor Q0. The PMOS transistors Q11 and Q12 control whether or not to supply line voltage Vcc to the first-stage amplifiers A11 and A12. The PMOS transistor Q10 controls both the PMOS transistors Q11 and Q12. The NMOS transistors Q2, Q3, Q4, and Q5 control whether or not to supply power by connecting, to the GND potential, the differential amplifiers A2 and A3, the comparator CMP and the buffer B. The NMOS transistor Q0 controls all of the NMOS transistors Q2 to Q5.

Drains of the PMOS transistors Q11 and Q12 are connected respectively to the differential amplifiers A2 and A3 at a high-level side of each power input. Sources of the PMOS transistors Q11 and Q12 are commonly provided with the line voltage Vcc. Gates of the PMOS transistors Q11 and Q12 are commonly connected to a drain of PMOS transistor Q10. A source of the PMOS transistor Q10 receives the voltage Vcc. A gate of the PMOS transistor A10 receives an output from an inverter INV1. The INV1 is a first one of two stages of inverters INV1 and INV2, which constitute the shutdown circuit 14. A drain of the PMOS transistor Q10, in other words, gates of the PMOS transistors Q11 and Q12, is also provided with a low-level bias PBIAS through a pull-down resistance and the like (not shown). Both power inputs at low-level sides of the first-stage amplifiers A11 and A12 are connected to the GND potential (not shown).

Drains of the NMOS transistors Q2, Q3, Q4, and Q5 are connected respectively to low-level sides of power inputs of the differential amplifiers A2 and A3, the comparator CMP and the buffer B. All sources of the NMOS transistors Q2, Q3, Q4, and Q5 are connected to the GND potential. All gates of the NMOS transistors Q2, Q3, Q4, and Q5 are connected to a drain of the NMOS transistor Q0. A source of the NMOS transistor Q0 is connected to the GND potential. A gate of the NMOS transistor Q0 receives an output from the inverter INV2, which is a second stage of the two stages of inverters in the shutdown circuit 14. The drain of the NMOS transistor Q0, in other words, gates of NMOS transistors Q2, Q3, Q4, and Q5 are also provided with a high-level bias NBIAS through a pull-up resistance and the like (not shown). Power source inputs at high-level sides of the differential amplifiers A2 and A3, the comparator CMP and the buffer B are commonly provided with the line voltage Vcc (not shown).

While the shutdown signal is of a low level, therefore, an output from the inverter INV1 becomes high level so as to turn OFF the PMOS transistor Q10, thereby making the gates of the PMOS transistors Q11 and Q12 biased into low level so as to turn ON the PMOS transistors Q11 and Q12 and so as to supply a desired constant current to the first-stage amplifiers A11 and A12. Similarly, when the shutdown signal is of a low level, an output from the inverter INV2 becomes low level so as to turn OFF the NMOS transistor Q0, thereby making the gates of the NMOS transistors Q2 to Q5 biased into high level so as to turn ON the NMOS transistors Q2 to Q5 and so as to supply a desired constant current to the differential amplifiers A2 and A3, the comparator CMP and the buffer B.

When the shutdown signal becomes high level, on the other hand, an output from the inverter INV1 becomes high level so as to turn ON the PMOS transistor Q10, thereby making the gates of the PMOS transistors Q11 and Q12 high level so as to turn OFF the PMOS transistors Q11 and Q12 and so as not to supply a desired constant current to the first-stage amplifiers A11 and A12. Similarly, when the shutdown signal becomes high level, an output from the inverter INV2 becomes high level so as to turn ON the NMOS transistor Q0, thereby making the gates of the NMOS transistors Q2 to Q5 low level so as to turn OFF the NMOS transistors Q2 to Q5 and so as not to supply a desired constant current to the differential amplifiers A2 and A3, the comparator CMP, and the buffer B.

Thus, when operation of the optical receiver circuit 11 is not necessary, a bias current provided to each internal circuit can be shutted-down by making the shutdown signal high level to shutdown the bias circuit 13. This can attain low electric power consumption of the optical receiver circuit 11. For example, power consumption of the optical receiver circuit 11, when normally operated, is on average 2 mA, while the power consumption of the optical receiver circuit 11 is at a maximum 1 μA at an occasion of shutdown. With this arrangement, for example, the stand-by time of a terminal of mobile phone can be extended from 250 hours to 300 hours when a 500 mAH buttery is loaded to the terminal of mobile phone.

In realizing such shutdown control for low electric power consumption, it is possible to directly supply electric power from a main regulator (not shown) and a smoothing capacitor by building the shutdown circuit 14 and the MOS transistors Q10 and Q0 into a chip of the optical receiver circuit 11. This leads to cost saving by, for example, reducing packaging area by 16% compared with a case where a regulator IC for shutdown control and a smoothing capacitor thereof are placed along a path. Moreover, because the current consumption by the regulator IC for shutdown control and the smoothing capacitor thereof is no longer involved, a current consumption required for operation can be reduced, for example on average from 12 mA to 2 mA. In other words, the current consumption is reduced to one sixth. In this case, assuming Vcc=1.5V, electrical power consumption is 3 mW.

In the bias circuit 13, which normally has a diode arrangement, the MOS transistors Q11, Q12; Q2 to Q5, which are the first MOS transistors to provide constant current to an internal circuit, are separated in accordance with polarities, and the MOS transistors Q11, Q12; Q2 to Q5 are collectively controlled by MOS transistors Q10 and Q0, each of which are the second MOS transistors. When the transistors Q11, Q12; Q2 to Q5 are composed of a bipolar transistor, it is necessary to supply a base current to the transistors Q10 and Q0, which are to be turned ON at an occasion of shutdown. When the transistors Q11, Q12; Q2 to Q5 are composed of a MOS transistor, on the other hand, it is only necessary to apply a voltage to the gate, thereby attaining further reduction of electric power consumption by eliminating an unnecessary flow of current.

Furthermore, when the output circuit 12 is composed of a bipolar transistor, it is necessary to adopt open-collector format and to load an external pull-up resistance in order to ensure wide amplitude range of the output Vout of the output circuit 12. Furthermore, in order to speed up response of the output Vout, it is necessary to reduce a value of the pull-up resistance. When the value of the pull-up resistance is reduced, CR time constant is reduced. Here, the CR time constant means the CR time constant between (a) the pull-up resistance and (b) a parasitic capacitance of the bipolar transistor or a load capacitance of same. This results in increase in a load current flowing through the pull-up resistance. On the other hand, when the output circuit 12 is composed of MOS transistors QP and QN, the load current does not increase because response of the MOS transistor is determined by an ON resistance. Thus, sufficient response speed can be realized with low electric power consumption.

As described above, the embodiment of the present invention adopts a BiCMOS process, in which a MOS process is added to a bipolar process, and is provided with the amplifiers A11, A12, A2, and A3, the comparator CMP and the buffer B and the like. Thus, the MOS process also produces the MOS transistors Q11, Q12; Q2 to Q5, and Q0.

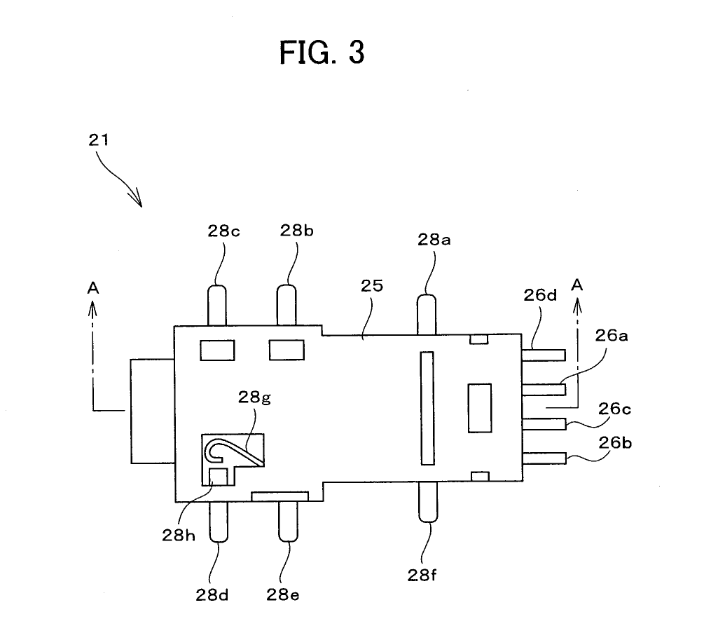

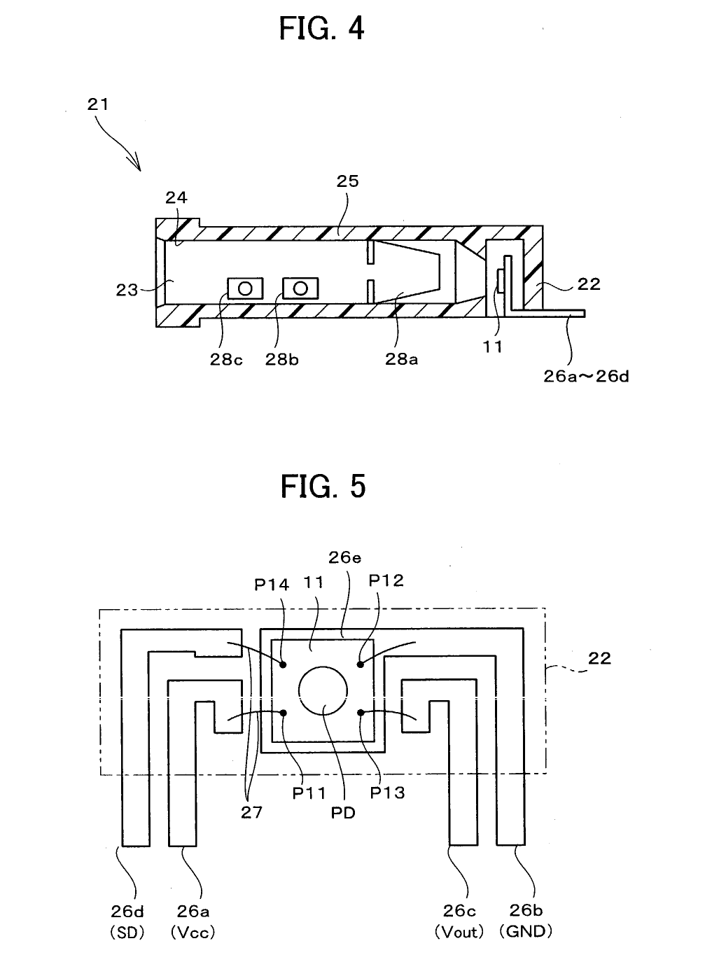

FIGS. 3 to 6 show an embodiment of an optical/electrical common transmission apparatus 21, which is provided with a chip of the optical receiver circuit 11 described above. FIG. 3 is a plan view. FIG. 4 is a cross sectional view taken on line A-A of FIG. 3. FIG. 5 is a front view of a module 22, which is provided with a chip of the optical receiver circuit 11. In this optical/electrical common transmission apparatus 21, the module 22 is placed at an opposite side of an inserting slot 24 of a plug 23. The chip of the optical receiver circuit 11 opposes to a head of the plug 23.

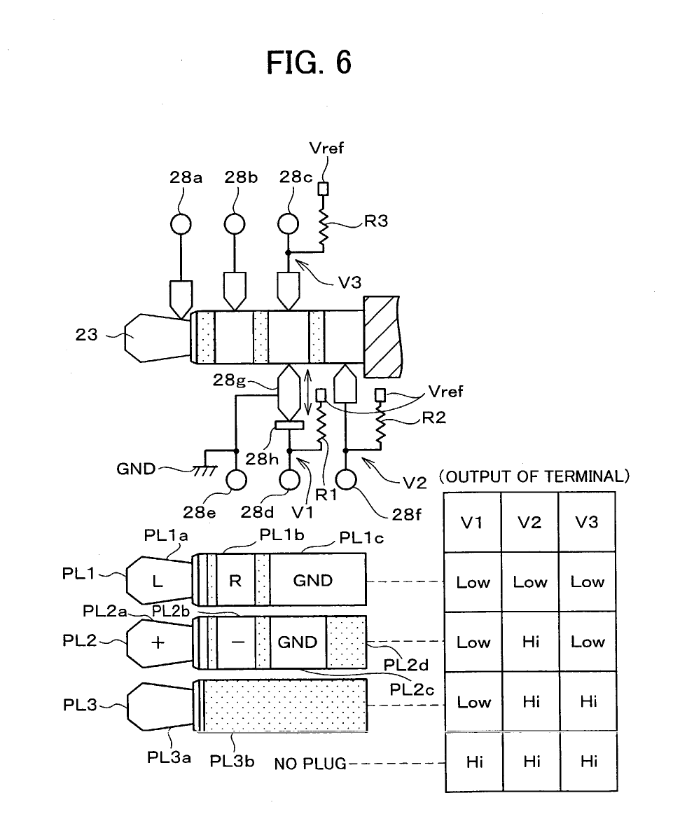

FIG. 6 shows how detection as to whether or not the plug 23 is inserted and as to which type of the plug 23 is inserted is carried out. The plug 23 is produced based on a so-called audio-use stereo mini plug PL1 of a single-head type. The plug PL1 has (a) a head PL1a for an L-channel signal, (b) a short joint PL1b, connected thereto, for an R-channel signal, and (c) a long joint PL1c, which is further connected thereto, as a common LR for the GND. With this arrangement, the plug PL1 allow an analog audio signal to be transmitted through an electric cable.

On the other hand, a plug PL2, which transmits a digital audio signal through an electric cable, has (a) a head PL2a for a plus signal, (b) a short joint PL2b, connected thereto, for a minus signal, (c) a short joint PL2c, which is further connected thereto, for the GND, and (d) a short joint PL2d, which is further connected thereto, being insulated.

Meanwhile, a plug PL3, which transmits a digital audio signal through an optical fiber, has (a) a head PL3a made of metal, and (b) a long joint PL3b, connected thereto, being insulated. The optical fiber runs through the PL3a and PL3b, which have tube-like shapes, so as to communicatively connect the PL3a and PL3b. An end of the optical fiber is exposed from a top of the head PL3a.

The optical/electrical common transmission apparatus 21 is, schematically, composed of a tube-like-shaped supporting body 25 and the module 22. The supporting body 25 has the inserting slot 24 inside. As mentioned before, the module 22 is located at an end of the inserting slot 24. The module 22 is provided with four terminals 26a, 26b, 26c, and 26d, which are externally extended from a rim of the chip of the optical receiver circuit 11. The terminals P11, P12, P13, and P14 of the chip are respectively connected with the terminals 26a, 26b, 26c, and 26d electrically by bonding wires 27. The terminal 26a becomes an input terminal of the line voltage Vcc; the terminal 26b becomes an input terminal of the earth potential GND; the terminal 26c becomes an input terminal of the output signal Vout; and the terminal 26d becomes an input terminal of the shutdown signal.

After the chip of the optical receiver circuit 11 is mounted on a frame 26e connected to the terminal 26b of the GND potential and after the terminals 26a, 26b, 26c, and 26d are internally connected to the chip by wire bonding, the module 22 is formed by molding by using translucent resin. Thus, in the module 22, the terminals 26a, 26b, 26c, and 26d are molded integrally. For example, the optical receiver circuit 11 has a chip size of 1.3 mm×1.3 mm; the terminals 26a, 26b, 26c, and 26d have a width of 0.4 mm.

Meanwhile, the supporting body 25 is provided with terminals 28a, 28b, 28c, 28d, 28e and 28f, which are formed from an internal circumference surface of the inserting slot 24 toward outside for electric connection. The terminals 28a, 28b and 28c, which are for transmitting an audio signal, correspond to the plugs PL1 and PL2. When the plugs PL1 or PL2 are inserted in the inserting slot 24, the terminals 28a, 28b, and 28c are electrically connected to PL1a, PL2a; PL1b, PL2b; PL1c, and PL2c, respectively.

On the other hand, the terminals 28d, 28e and 28f are for detecting whether or not the plug 23 is inserted and as to which type of the plug 23 is inserted. Outside the optical/electrical common transmission apparatus 21, the terminal 28d is connected to the reference voltage Vref through a pull-up resistance R1; the terminal 28e is connected to the GND; and the terminal 28f is connected to the reference voltage Vref through a pull-up resistance R2. The terminal 28c is also connected to the reference voltage Vref through a pull-up resistance R3 located outside the optical/electrical common transmission apparatus 21. The terminal 28e, which is a traveling contact 28g, forms a switch in combination with a fixed contact 28h, which is connected to the terminal 28d. When the plug 23 is inserted, the traveling contact 28g is pushed by the plug 23 so as to contact the fixed contact 28h. When the plug 23 is not inserted, the contacts 28g and 28h are separated.

Here, it is put that potentials of the terminals 28d, 28f and 28c connected to the reference voltage Vref through the pull-up resistances R1, R2 and R3 are referred to as V1, V2 and V3, respectively. As shown in FIG. 6, when the potential V1 becomes low level by electric connection between the contacts 28g and 28h, and the other potentials V2 and V3 also become low level by electric connection among the terminals 28f, 28c and 28e at the long joint PL1c, it is determined that the plug PL1 for analog signal is inserted. When the potential V1 becomes low level by electric connection between the contacts 28g and 28h, and the potential V2 becomes high level by insulation of the terminal 28f at the short joint PL2d, and the potential V3 becomes low level by electric connection between the terminals 28c and 28e at the short joint PL2c, it is determined that the plug PL2 for digital electronic signal is inserted. Furthermore, when the potential V1 becomes low level by electric connection between the contacts 28g and 28h, and the potentials V2 and V3 become high level by insulation among the terminals 28f, 28c and 28e at the long joint PL3b, it is determined that the plug PL3 for optical digital signal is inserted. When the potential V1 becomes high level by blocking between the contacts 28g and 28f and the other potentials V2 and V3 also become high level by opening among the terminals 28f, 28c and 28e, it is determined that none of the plugs PL1 to PL3 is inserted.

Thus, it can be understood that regardless of which one of the plugs PL1 to PL3 (the electronic analog plug PL1, the electronic digital plug PL2, or the optical digital plug PL3) is used, it is possible to detect whether or not one of the plugs PL1 to PL3 is inserted and, if inserted, which type the inserted plug is of, and it is possible to transmit a corresponding signal via the inserted plug.

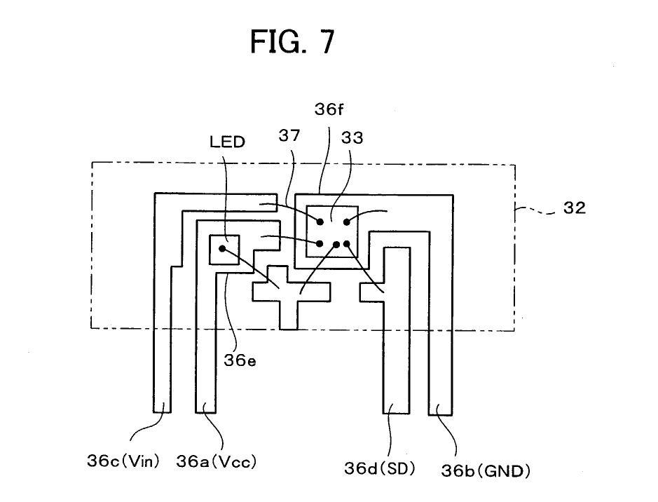

Although the above description discusses an example in which the chip mounted on the module 22 located in the optical/electrical common transmission apparatus 21 is the optical receiver circuit 11, the chip may be an optical transmitter circuit. FIG. 7 shows an example of a module 32 in which the optical receiver circuit 11 is used. The module 32 is provided with a light-emitting element LED and a driving circuit 33 having the shutdown circuit. The driving circuit 33 drives the light-emitting element LED. After a chip of the light-emitting element LED is mounted on a frame 36e, which is connected to an input terminal 36a, a chip of the driving circuit 33 is mounted on a frame 36f, which is connected to a terminal 36b of the GND potential. Then, the chip is electrically connected with the input terminal 36a for the line voltage Vcc, the terminal 36b for the GND potential, and an input terminal 36c for an input signal Vin and/or an input terminal 36d for a shutdown signal by bonding wires 37, respectively. Thereafter, the module 22 is formed by molding with translucent resin.

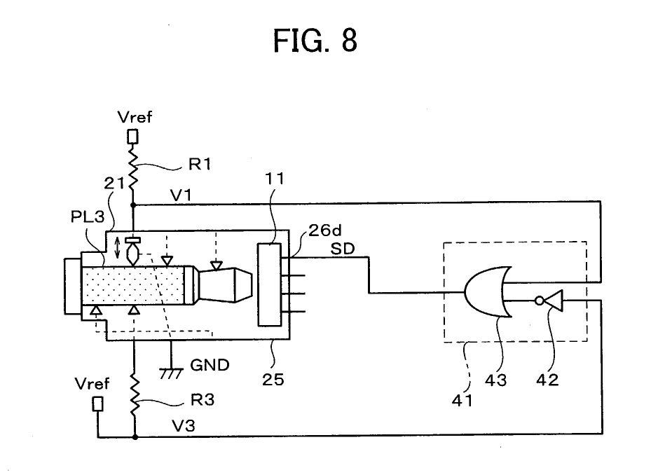

FIGS. 8 to 11 respectively show how a shutdown control is carried out. Although in these examples the chip of the optical receiver circuit 11 is used as the optical/electrical common transmission apparatus 21, a chip of the light-emitting element LED and the driving circuit 33 would serve the same purpose. Examples in FIGS. 8 to 10 pay attention to a fact that, from the FIG. 6, it is apparent that power supply to the optical receiver circuit 11 is only required when the potential V1 is of a low level and the potential V3 is of a high level by inserting the plug PL3 for optical digital signal, and that in other cases only shutdown is necessary. In short, the examples above use the potentials V1 and V3 as a means for detecting whether or not the plug is inserted, and which type of the plug is inserted.

FIG. 8 is an example where a simple logic circuit 41 is located outside the optical/electrical common transmission apparatus 21 to be used as a control circuit for determining whether or not a shutdown is necessary. The logic circuit 41 is composed of an inverter 42 and an OR circuit 43. The potential V1 is directly supplied to one of inputs of the OR circuit 43, while the potential V3 is inverted by the inverter 42 and supplied to the other of the inputs of the OR circuit 43. Therefore, a shutdown signal SD supplied by the OR circuit 43 to the terminal 26d becomes low level only when both the inputs of the OR circuit 43 are of a low level, in other words, when the potential V1 is of a low level and the potential V3 is of a low level. In other cases the shutdown signal SD becomes high level.

Thus, simply by adding the simple logic circuit 41, it is possible to perform shutdown control in which power is supplied only when the plug 23 is inserted and is the plug PL3 for optical digital signal, and power is not supplied when the plug 23 is not inserted or, if inserted, when it is either electrical plugs PL1 or PL2.

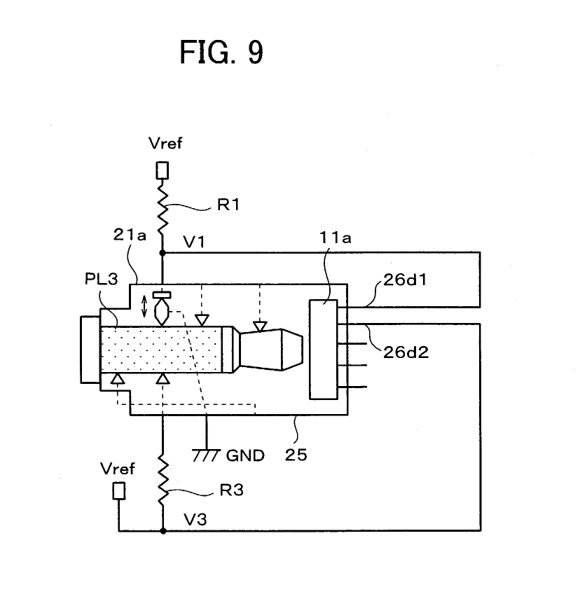

An example in FIG. 9 uses an optical receiver circuit 11a having a function of an internal determination circuit for determining whether or not a shutdown is necessary. More specifically, the optical receiver circuit 11a includes another circuit similar to the logic circuit 41, and the optical receiver circuit 11a has two terminals 26d1 and 26d2 as input terminals for the shutdown signals. This arrangement makes it possible to input the potentials V1 and V3 as a means for detecting whether and which type of the plug is inserted.

Hereby it becomes possible to properly control shutdown according to a result of determinations carried out inside the optical/electrical common transmission apparatus 21a. At the same time, it is possible to control shutdown without imposing software-related burden (consumption of computing power of a microcomputer and the like when a software is executed, and/or additional workload for an engineer to prepare a software that is to be executed by the microcomputer and the like) on external microcomputers and the like because the control is performed internally through simple logic processing.

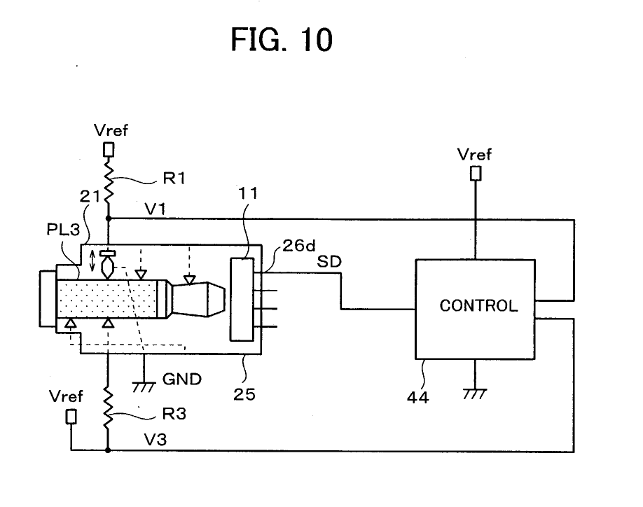

FIG. 10 is an example where a control circuit 44 is located outside the optical/electrical common transmission apparatus 21 for determining whether or not a shutdown is necessary. A microcomputer or a digital signal processor (DSP), which is provided for processing a digital signal, can also serve as the control circuit 44. The potentials V1 and V3 for detecting whether or not the plug is inserted and which type of the plug is inserted are inputted to the control circuit 44. In response to the input of the potentials V1 and V3, the control circuit 44 outputs the shutdown signal SD to the terminal 26d of the optical receiver circuit 11.

Hereby it becomes possible to control the shutdown without providing a separate circuit for exclusive use such as the logic circuit 41. Moreover, it is also possible to perform controls such as control to end the shutdown when a given delay time has passed since the detection as to whether the plug is inserted and which type of the plug is inserted.

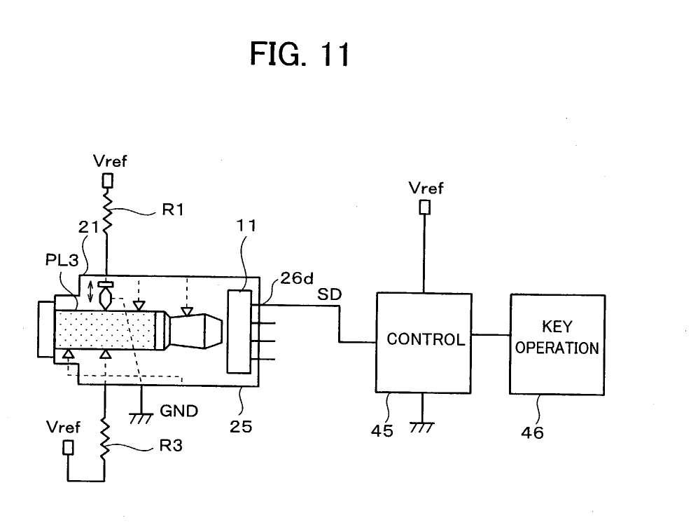

FIG. 11 shows an example where, like the example in FIG. 10, a control circuit 45 made of an external microcomputer or a DSP for digital-signal processing is used, and the control circuit 45 controls a shutdown by determining whether or not the shutdown is necessary in response to an operation to a key operation circuit 46.

Hereby it becomes possible, for example, when audio data is downloaded from a digital audio apparatus to a terminal of a mobile phone, to realize such control as to supply power to the optical receiver circuit 11 after the terminal becomes ready to record, that is to perform a shutdown control according to a state of an apparatus. Needless to say, the shutdown may be performed more specifically by inputting the potentials V1 and V3 to the control circuit 45 in accordance with the external operation and results of a plug insertion detection and a plug type detection.

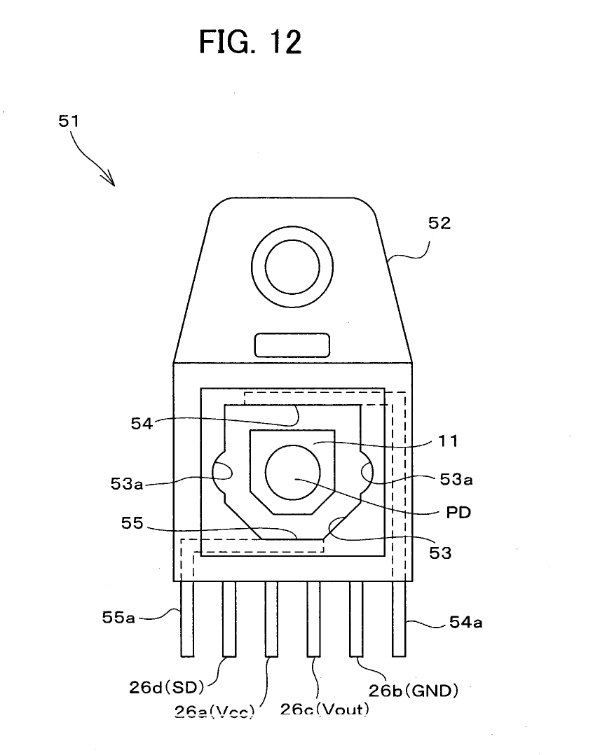

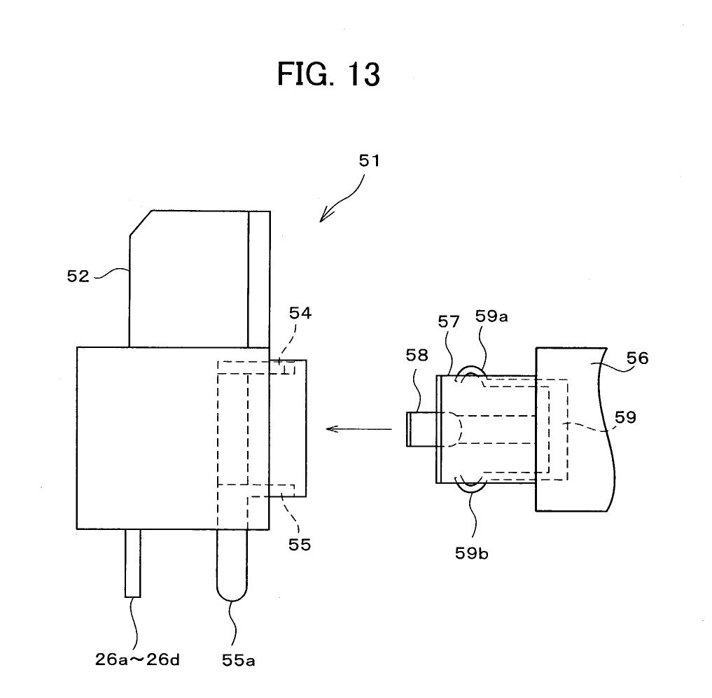

The following describes another embodiment of the present invention with reference to FIGS. 12 and 13.

FIG. 12 is a front view of an optical transmission apparatus 51 of another embodiment of the present invention which is provided with an optical receiver circuit 11, and FIG. 13 is its side view. In FIGS. 12 and 13, the sections corresponding to those in FIGS. 3 to 5 are labeled in the same manner, and thus descriptions thereof are omitted. The optical transmission apparatus 51 is a square-shaped optical transmission apparatus in conformity with a digital audio interface standard RC-5720B. In a supporting body 52 for containing and supporting the optical receiver circuit 11, a substantially square-shaped inserting slot 53 is formed. The optical receiver circuit 11 is located behind the inserting slot 53. Electrifiable contact plates 54 and 55 face a pair of internal circumference surfaces (top surface and bottom surface in FIG. 12 and FIG. 13), which face each other in the square-shaped inserting slot 53. The contact plates 54 and 55 are linked with terminals 54a and 55a, which externally extend from outer circumference surface of the supporting body 52 (bottom surface in FIG. 12 and FIG. 13). On an internal circumference surface of the inserting slot 53, a pair of springs 53a for generating a spring force to support a plug 56 inserted is also located.

Correspondingly, a substantially square-shaped insert tube 57 is formed on the plug 56 to be inserted in the inserting slot 53. The insert tube 57 holds an optical fiber 58 therein. In the square insert tube 57, a plate-spring-like conductive contact plates 59a and 59b face a pair of outer circumference surfaces (top surface and bottom surface in FIG. 12 and FIG. 13). The contact plates 59a and 59b are mutually short-circuited inside the plug 56 by a short circuit plate 59.

Thus, when the plug 56 is inserted in the inserting slot 53, a tip surface of the optical fiber 58 is engaged with an acceptance surface of the photodiode PD, and the contact plates 54 and 55 are mutually short-circuited by the contact plates 59a and 59b, and the short circuit plate 59. Therefore, the shutdown can be controlled by performing insert detection (detection as to whether or not the plug is inserted) from a potential of the terminal 54a by, for example, pulling up the terminal 54a to the power source Vcc with a pull-up resistance and the like, and by using the terminal 55a of a GND potential.

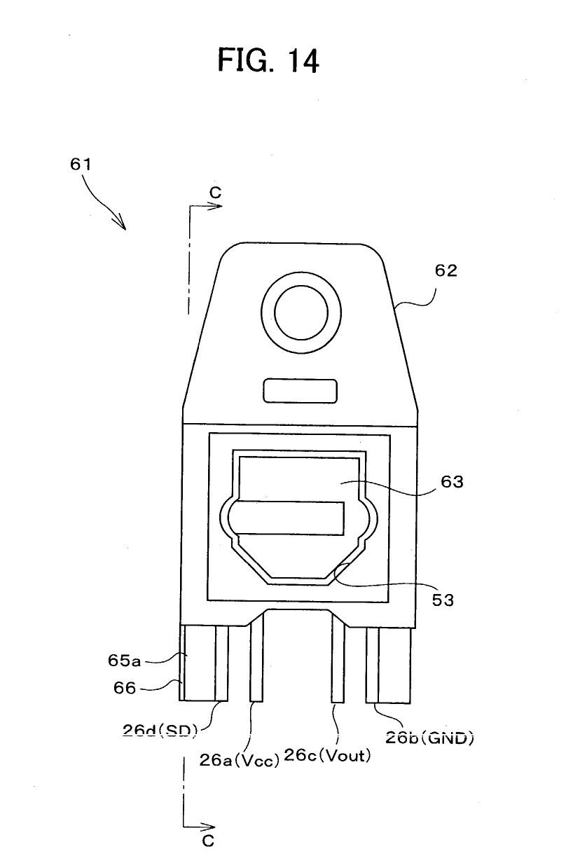

The following describes a further embodiment of the present invention with reference to FIGS. 14 to 17.

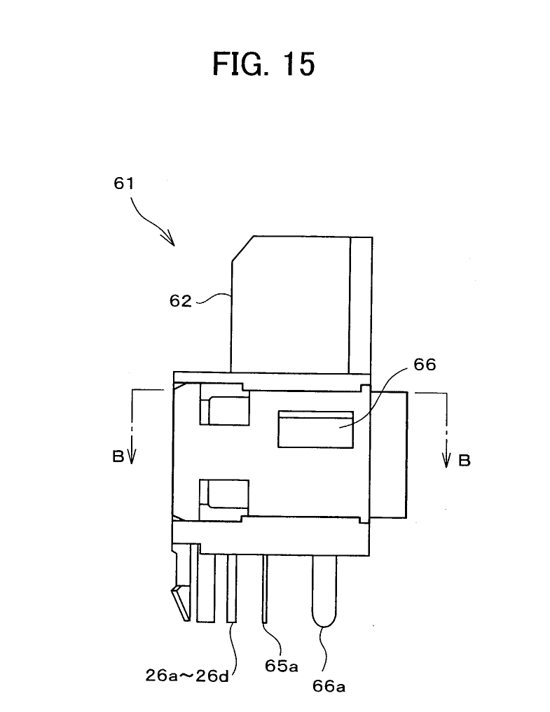

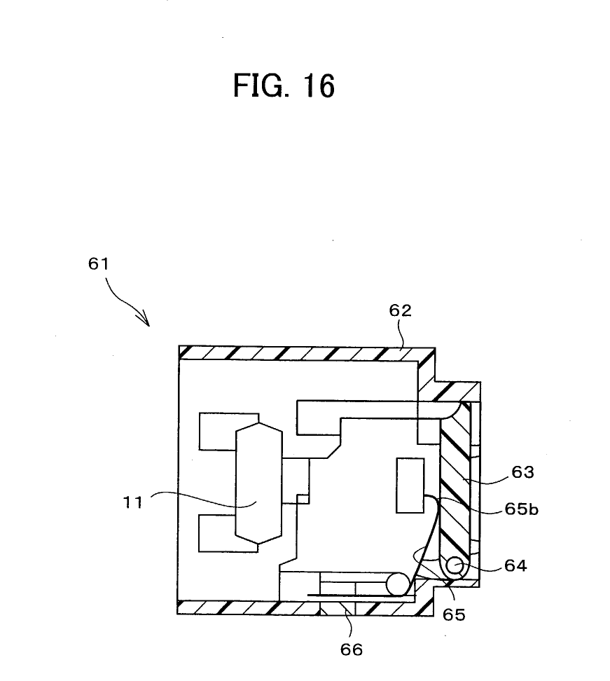

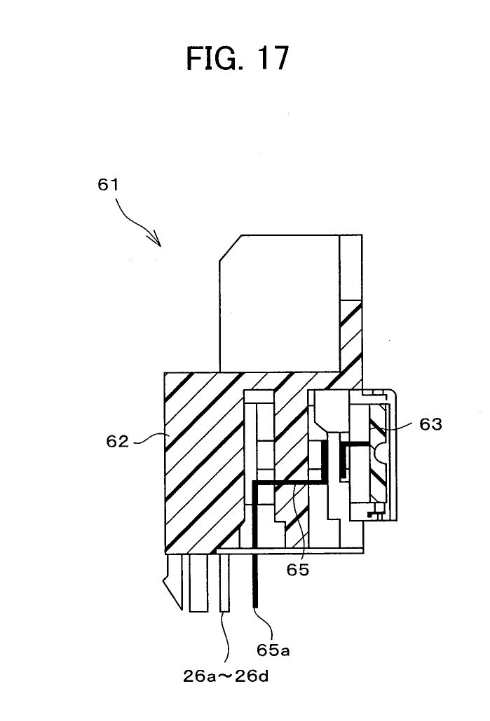

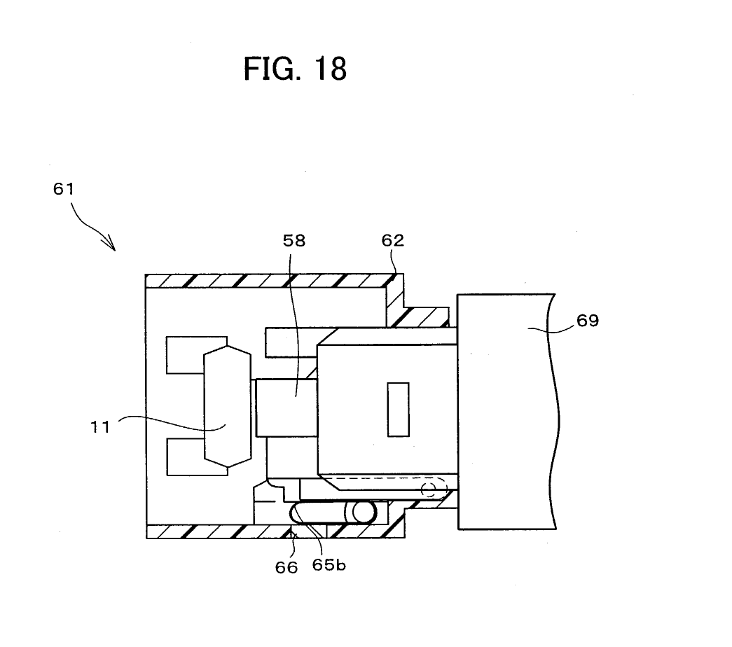

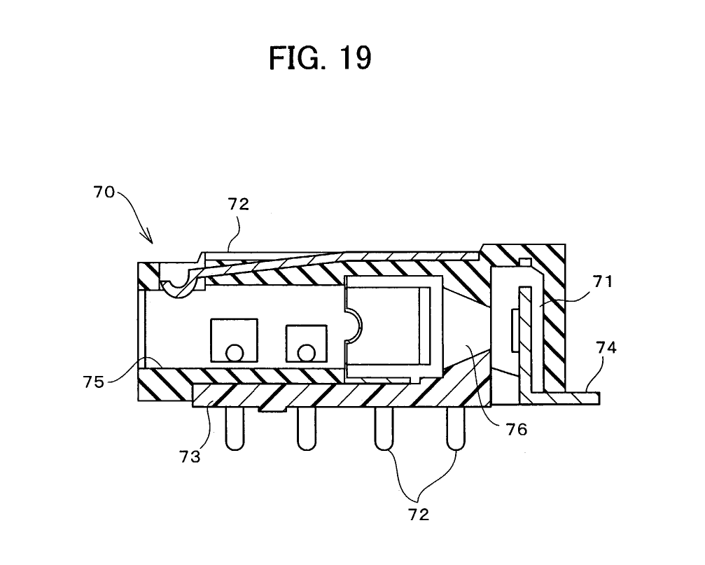

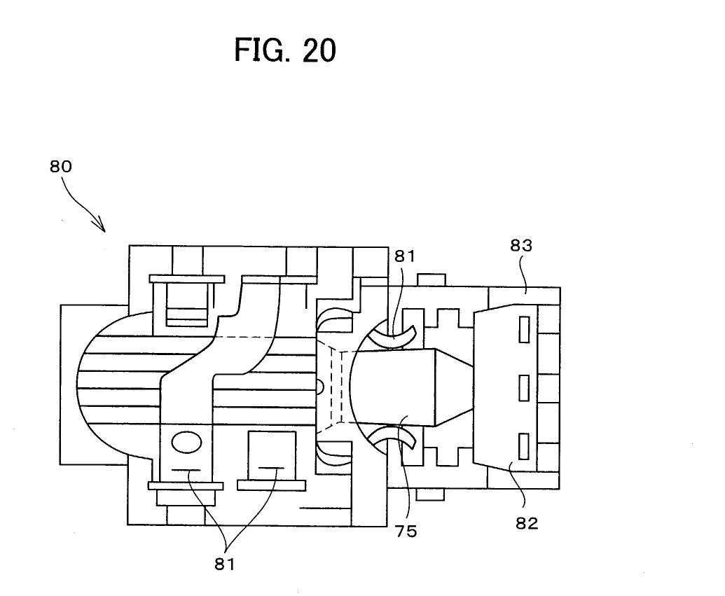

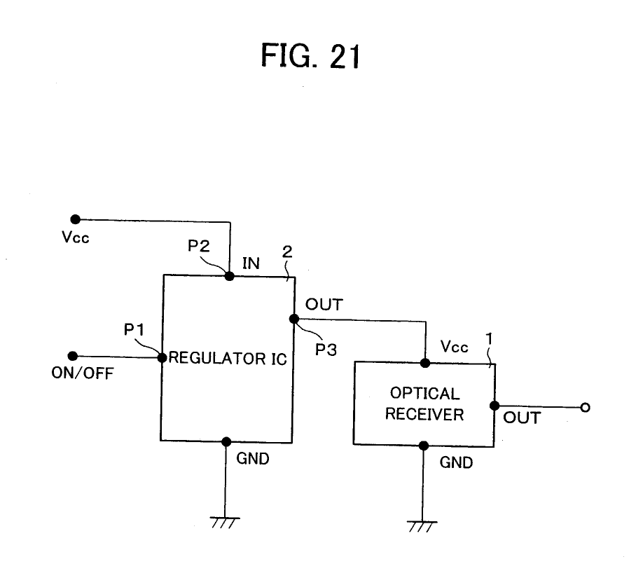

FIG. 14 is a front view of an optical transmission apparatus 61, which is a further embodiment of the present invention provided with an optical receiver circuit 11. FIG. 15 is a side view thereof. FIG. 16 is a cross-sectional view taken on line B-B of FIG. 15. FIG. 17 is a cross-sectional view taken on line C-C of FIG. 14. FIG. 18 is a cross-sectional view, illustrating a state in which the plug 69 is inserted in FIG. 16. Because the optical transmission apparatus 61 is similar to the optical transmission apparatus 51, corresponding sections are labeled in the same manner, and thus descriptions thereof are omitted. Attention should be paid to an arrangement in which the optical transmission apparatus 61 has a shutter 63 at an inserting slot 53.

Correspondingly, a supporting body 62 is provided with a pair of pins 64 (an upper pin and a lower pin), which support, oscillating freely, an edge of a shutter 63 around vertical shaft line. A spring 65 is also provided, which press the shutter 63 from inside toward outside. In the supporting body 62, a part of an interior wall 66 is made of conductive resin or metal terminal. An edge 65b of the spring 65, which pushes the shutter 63, corresponds to the interior wall 66. The spring 65 and the interior wall 66 are extended to outside and become terminals 65a and 66a.

Therefore, the spring 65 and the interior wall 66 constitute a switch, which turns ON or OFF depending on whether or not the plug 69 is inserted. More specifically, when the plug 69 is not inserted and the shutter 63 is closed, the edge 65b of the spring 65 is separated from the interior wall 66, thereby blocking the terminals 65a and 66a. On the other hand, when the plug 69 is inserted, the shutter 63 is opened, and the edge 65b of the spring 65 touches the interior wall 66, thereby electrically connecting the terminals 65a and 66a. In this way, whether or not the plug 69 is inserted can be detected from open/close state of the shutter 63.

In this arrangement, it is not necessary to have a metal terminal used exclusively to detect whether or not the plug is inserted, such as the contact plates 54 and 55. Whether or not the plug is inserted may also be detected, by making the shutter 63 of conductive resin or metal terminal and by connecting the shutter 63 to an external terminal, from whether or not the shutter 63 and the interior wall 66 is electrically connected.

The chip of the optical receiver circuit 11, the chip of the light emitting element LED and the driving circuit 33, and the transmission apparatuses 21, 51 and 61 which contain at least one of the chips of the present embodiment, are suitably used at least in electronic devises that use optical communication and especially in those portable devises where needs for electricity saving is strong because the chip of the optical receiver circuit 11, the chip of the light emitting element LED and the driving circuit 33, and the transmission apparatuses 21, 51 and 61 which contain at least one of the chips of the present embodiment can realize the shutdown control with almost no increase in a chip area of a circuit.

As described above, an optical communication circuit chip (the chips of the optical receiver circuits 11 and 11a and the chip of the driving circuit 33) of the present invention for converting an electrical signal into an optical signal and communicating by using the optical signal includes a shutdown circuit (14) for blocking power supply to an internal circuit (the photodiode PD, the amplifiers A11, A12, A2, and A3, the comparator CMP, and the buffer B and the like) in response to a shutdown signal inputted externally thereto.

According to the arrangement above, in the optical communication circuit chip including a photo acceptance unit (the photodiode PD) and a signal processing circuit (the amplifiers A11, A12, A2, and A3, the comparator CMP, and the buffer B and the like) for amplifying or wave shaping a signal received by the photo acceptance unit, or a light-emitting element (LED) and a driving circuit (33) for amplifying a transmission signal and supplying the transmission signal to the light-emitting element, the shutdown circuit controls whether or not to supply power to the internal circuit such as the photo acceptance unit and the signal processing circuit in response to the shutdown signal from an external control circuit (44 and 45) and the like, which is inputted in accordance with whether a plug for a transmission medium such as optical fiber is inserted into a corresponding jack or in accordance with user's operation and the like.

Thus, in realizing the shutdown control for low electric power consumption, the arrangement above makes it possible, by building-in the shutdown circuit into the optical communication circuit chip, to prevent increase of substrate space and costs compared with a case in which a regulator IC is separately used.

Furthermore, an optical communication circuit chip of the present invention may include a bias circuit (13), which includes a first MOS transistor (Q2 to Q5, Q11 and Q12) for supplying a constant current to the internal circuit, for supplying power to the internal circuit, the shutdown circuit including a second MOS transistor (Q0 and Q10) for controlling a gate of the first MOS transistor, and a control circuit (inverters INV1 and INV2) for driving the second MOS transistor in response to the shutdown signal.

According to the arrangement above, in the bias circuit for supplying power to the internal circuit including photo acceptance unit and the signal processing circuit and the like, the first MOS transistors, which normally have a diode arrangement, for providing a constant current to the internal circuit are separated in accordance with polarities. The one or plurality of the first MOS transistors are collectively driven by the second MOS transistors.

Therefore, while it is necessary to supply a base current to a transistor to be turned ON at an occasion of shutdown in case where the first and the second transistors are composed of a bipolar transistor, when the first and the second transistors are composed of a MOS transistor, electric power consumption can be further reduced by eliminating an unnecessary flow of current.

Furthermore, in the optical communication circuit chip of the present invention, an output-stage circuit (the output circuit 12) may be composed of the MOS transistors (QP and QN).

Here, when the output-stage circuit is composed of a bipolar transistor, in order to ensure wide amplitude range, it is necessary to adopt open-collector format and to externally provide a pull-up resistance. Furthermore, in order to speed up response of the output signal, it is necessary to reduce a value of the pull-up resistance. This results in increase in a load current flowing through the pull-up resistance.

According to the arrangement above, on the other hand, by using a MOS transistor, the load current does not increase. Thus, sufficient response speed can be realized with low electric power consumption.

Furthermore, An optical/electrical common transmission apparatus of the present invention (21 and 21a) includes (a) a circuit section (optical receiver circuits 11 and 11a, and a driving circuit 33) having a light-electricity converting element (a photodiode PD and a light-emitting element LED) and (b) a light-electricity common jack section (supporting bodies 25, 52, and 62), the optical/electrical common transmission apparatus being capable of transmitting an optical signal via a transmission medium for the optical signal when a plug connected to an end of the transmission medium is inserted into the light-electricity common jack section, and capable of transmitting an electrical signal via a transmission medium for the electrical signal when a plug, which has a similar shape to that of the plug for the optical signal, connected to an end of the transmission medium is inserted into the light-electricity common jack section, wherein the circuit section further includes a signal processing circuit (amplifiers A11, A12, A2, and A3, a comparator CMP, and a buffer B and the like) for the light-electricity converting element and a shutdown circuit (14) for blocking power to the light-electricity converting element and to the signal processing circuit in response to a shutdown signal, which is externally inputted into a shutdown terminal (P14).

According to the arrangement above, in the optical/electrical common transmission apparatus capable of transmitting an optical signal by adding, to a transmission apparatus for electrical signal realized by so-called audio-use stereo mini plug and jack, (a) a plug and a jack similar to the stereo mini plug and jack and (b) the optical fiber as a transmission medium, the shutdown circuit is further provided, within the same chip, in the circuit section which is provided with the light-electricity converting element such as a photodiode and a light-emitting diode, and a signal processing circuit for the light-electricity converting element such as a light receiver amplifier circuit and a driving circuit.

Then, according to the arrangement above, the shutdown circuit blocks power to the light-electricity converting element and to the signal processing circuit in response to the shutdown signal, which is externally inputted into a shutdown terminal in accordance with a state of a contact point of the plug inserted into the jack and in accordance with user's operation and the like.

Thus, the arrangement above achieves (a) the shutdown control for low electric power consumption with almost no increase in a chip area of the circuit section, as well as (b)use of the plug and jack for both the optical signal and the electrical signal.

For example, as shown in FIG. 8, the optical/electrical common transmission circuit 21 is provided with the shutdown circuit and the logic circuit 41. The optical/electrical common transmission circuit 21 constitutes an optical fiber link and converts a received optical signal into an electrical signal. The shutdown circuit is built-in into a chip of the optical receiver circuit 11 having the photodiode, the signal processing circuit thereof, and the like. The logic circuit 41 detects, from the potentials V1 to V3 and the like, whether or not the plug PL3 is inserted in the jack section and which type of the plug is inserted. The logic circuit 41 outputs the shutdown signal SD to the chip of the optical receiver circuit 11 when it is determined that the shutdown is necessary. Therefore, the shutdown control for electricity saving can be realized while suppressing increase in a chip area of the optical receiver circuit 11.

An optical/electrical common transmission apparatus of the present invention may be so arranged that the light-electricity common jack section includes a plug insertion detection means (The contacts 28g and 28h, and the resistances R1 to R3) and a plug type detection means (The contacts 28g and 28h, and the resistances R1 to R3), and that a control circuit (44) externally connected with the optical/electrical common transmission apparatus determines whether or not the shutdown is necessary, in response to detection results of the plug insertion detection means and the plug type detection means, and outputting the shutdown signal to the shutdown terminal when it is determined that the shutdown is necessary.

According to the arrangement above, by using the control circuit, it is possible to properly control the shutdown of the light-electricity converting element and the signal processing circuit in response to whether the plug is inserted and which type of the plug is inserted. In other words, power is supplied only when the plug is inserted and the plug is an optical plug. The power supply is blocked when the plug is not inserted and, even if inserted, when the plug is an electrical plug.

Furthermore, an optical-electrical common transmission apparatus of the present invention may be so arranged that the light-electricity common jack section includes a plug insertion detection means and a plug type detection means (The contacts 28g and 28h, and the resistances R1 to R3), and the circuit section includes an internal determination circuit (11a) for determining whether or not the shutdown is necessary in response to detection results of the plug insertion detection means and the plug type detection means, and outputting the shutdown signal to the shutdown terminal when it is determined that the shutdown is necessary.

According to the arrangement above, by using the internal determination circuit, it is possible to properly control the shutdown of the light-electricity converting element and the signal processing circuit in response to whether the plug is inserted and which type of the plug is inserted. In other words, power is supplied only when the plug is inserted and the plug is an optical plug. The power supply is blocked when the plug is not inserted and, even if inserted, when the plug is an electrical plug. Furthermore, no software-related burden is imposed on an external microcomputer and the like because the control is performed internally through simple logic processing.

An optical/electrical common transmission apparatus of the present invention may be so arranged as to be externally connected with a control circuit 45 for determining whether or not the shutdown is necessary in response to external key operation, and outputting the shutdown signal to the shutdown terminal when it is determined that the shutdown is necessary.

According to the arrangement above, it is possible to perform a complicated shutdown control in accordance with the external operation. For example, it is possible to perform such a shutdown control that power is supplied only when record is carried out, while power is not supplied when other operation is carried out such as playing-back and the like.

Furthermore, an optical transmission apparatus of the present invention (21 and 21a) for performing optical transmission via an optical fiber includes (a) a circuit section (optical receiver circuits 11 and 11a, a driving circuit 33) having a light-electricity converting element (a photodiode PD and a light-emitting element LED), and (b) a jack section (supporting bodies 25, 52, and 62), into which a plug (23, 56, and 69), connected to an end of the optical fiber, is inserted to enable the optical transmission apparatus to perform optical transmission, wherein the circuit section further includes a signal processing circuit (amplifiers A11, A12, A2, and A3, a comparator CMP, and a buffer B and the like) for the light-electricity converting element, and a shutdown circuit (14) for blocking power to the light-electricity converting element and the signal processing circuit in response to a shutdown signal which is externally inputted into a shutdown terminal (P14).

According to the arrangement above, in the optical transmission apparatus capable of transmitting the optical signal using the optical fiber as a transmission medium, the shutdown circuit is further provided, within the same chip, in the circuit section which is provided with the light-electricity converting element such as a photodiode and a light-emitting diode, and a signal processing circuit for the light-electricity converting element such as an light receiver amplifier circuit and a driving circuit.

Then, according to the arrangement above, the shutdown circuit blocks power to the light-electricity converting element and the signal processing circuit in response to the shutdown signal, which is externally inputted into a shutdown terminal in accordance with whether the plug is inserted into the jack and in accordance with user's operation and the like.

Thus, the arrangement above achieves the shutdown control for low electric power consumption with almost no increase in a chip area of the circuit section.

Furthermore, an optical transmission apparatus of the present invention may be so arranged as to be externally connected with a control circuit (45) for determining whether or not the shutdown is necessary in response to external key operation, and outputting the shutdown signal to the shutdown terminal when it is determined that the shutdown is necessary.

According to the arrangement above, it is possible to perform a complicated shutdown control in accordance with the external operation. For example, it is possible to perform such a shutdown control that power is supplied only when record is carried out, while power is not supplied when other operation is carried out such as playing-back and the like.

Furthermore, an optical transmission apparatus of the present invention may be so arranged that the jack section includes a second metal terminal (contact plates 54 and 55) that touches, when the plug is inserted, a predetermined first metal terminal (contact plates 59a and 59b) of the plug so as to detect whether or not the plug is inserted and to obtain a plug insertion detection result, and, that the circuit section includes an internal determination circuit (11a) for determining whether or not the shutdown is necessary in response to the plug insertion detection result via the second metal terminal and outputting the shutdown signal to the shutdown terminal when it is determined that the shutdown is necessary.

According to the arrangement above, by using the internal determination circuit, it is possible to properly control the shutdown of the light-electricity converting element and the signal processing circuit in response to whether the plug is inserted and which type of the plug is inserted. In other words, power is supplied only when the plug is inserted and the plug is an optical plug. The power supply is blocked when the plug is not inserted and, even if inserted, when the plug is an electrical plug. Furthermore, no software-related burden is imposed on an external microcomputer and the like because the control is performed internally through simple logic processing.

Furthermore, an optical transmission apparatus of the present invention may be so arranged that the jack section includes, at an inserting slot thereof, a shutter (63) and a switch (a spring 65 and an interior wall 66), which turns ON/OFF in accordance with an open/close state of the shutter, so as to obtain a switching detection result, and that the circuit section includes an internal determination circuit (11a) for determining whether or not the shutdown is necessary in response to turning ON and OFF of the switch, and outputting the shutdown signal to the shutdown terminal when it is determined that the shutdown is necessary.

According to the arrangement above, it is possible to properly control the shutdown of the light-electricity converting element and the signal processing circuit by (a) providing the jack section with a shutter at the inserting slot, and (b) forming a switch that terns ON or OFF in accordance with an open or closed state of the shutter by making, for example, the shutter and an interior wall of the jack electrically conductive. When the shutter opens or closes in accordance with whether or not the plug is inserted, from an ON or OFF state of the switch corresponding thereto, the internal determination circuit determines whether or not the shutdown is necessary. In other words, power is supplied only when the plug is inserted, while power is not supplied when the plug is not inserted. Furthermore, no software-related burden is imposed on an external microcomputer and the like because the control is performed internally through simple logic processing. Moreover, it is not necessary to provide the plug with a metal terminal for exclusive use in plug detection.

Furthermore, the electric apparatus of the present invention is so arranged as to include at least one of the optical/electrical common transmission apparatus, the optical transmission apparatus, and the optical communication circuit chip. This can realize an electric apparatus having low electricity consumption while suppressing increase in a chip area.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. An optical communication circuit chip for converting an electrical signal into an optical signal, and communicating by using the optical signal, comprising:
a shutdown circuit for blocking power supply to an internal circuit in response to a shutdown signal inputted externally thereto.

2. The optical communication circuit chip as set forth in claim 1, comprising:
a bias circuit, which includes a first MOS transistor for supplying a constant current to the internal circuit, for supplying power to the internal circuit,
the shutdown circuit including:
a second MOS transistor for controlling a gate of the first MOS transistor; and
a control circuit for driving the second MOS transistor in response to the shutdown signal.

3. The optical communication circuit chip as set forth in claim 2, wherein:
a circuit in an output stage includes a MOS transistor.

4. The optical communication circuit chip as set forth in claim 1, wherein:
a circuit in an output stage includes a MOS transistor.

5. An electronic apparatus including an optical communication circuit chip for converting an electrical signal into an optical signal, and communicating by using the optical signal, wherein:
the optical communication circuit chip includes a shutdown circuit for blocking power supply to an internal circuit in response to a shutdown signal inputted externally.

6. The electric apparatus as set forth in claim 5, comprising:
a bias circuit, which includes a first MOS transistor for respectively supplying a constant current to each internal circuit, for supplying power to the internal circuit,
the shutdown circuit including:
a second MOS transistor for controlling a gate of the first MOS transistor; and
a control circuit for driving the second MOS transistor in response to the shutdown signal.

7. The electric apparatus as set forth in claim 6, wherein:
a circuit in an output stage of the optical communication circuit chip includes a MOS transistor.

8. The electric apparatus as set forth in claim 5, wherein:
a circuit in an output stage of the optical communication circuit chip includes a MOS transistor.

9. An optical/electrical common transmission apparatus including (a) a circuit section having a light-electricity converting element and (b) a light-electricity common jack section, the optical/electrical common transmission apparatus being capable of transmitting an optical signal via a transmission medium for the optical signal when a plug for the optical signal connected to an end of the transmission medium is inserted into the light-electricity common jack section, and capable of transmitting an electrical signal via a transmission medium for the electrical signal when a plug for the electrical signal, which has a similar shape to that of the plug for the optical signal, connected to an end of the transmission medium is inserted into the light-electricity common jack section, wherein:
the circuit section further includes:
a signal processing circuit for the light-electricity converting element; and
a shutdown circuit for blocking power to the light-electricity converting element and to the signal processing circuit in response to a shutdown signal, which is externally inputted into a shutdown terminal.

10. The optical/electrical common transmission apparatus as set forth in claim 9, wherein:
the light-electricity common jack section includes a plug insertion detection means and a plug type detection means; and
a control circuit externally connected with the optical/electrical common transmission apparatus determines whether or not the shutdown is necessary, in response to detection results of the plug insertion detection means and the plug type detection means, and outputting the shutdown signal to the shutdown terminal when it is determined that the shutdown is necessary.

11. The optical/electrical common transmission apparatus as set forth in claim 9, wherein:
the light-electricity common jack section includes a plug insertion detection means and a plug type detection means; and
the circuit section includes an internal determination circuit for determining whether or not the shutdown is necessary in response to detection results of the plug insertion detection means and the plug type detection means, and outputting the shutdown signal to the shutdown terminal when it is determined that the shutdown is necessary.

12. The optical/electrical common transmission apparatus as set forth in claim 9, being externally connected with a control circuit for determining whether or not the shutdown is necessary in response to external key operation, and outputting the shutdown signal to the shutdown terminal when it is determined that the shutdown is necessary.

13. An electronic apparatus comprising an optical/electrical common transmission apparatus, wherein:
the optical/electrical common transmission apparatus includes (a) a circuit section having a light-electricity converting element and (b) a light-electricity common jack section, the optical/electrical common transmission apparatus being capable of transmitting an optical signal via a transmission medium for the optical signal when a plug for the optical signal connected to an end of the transmission medium is inserted into the light-electricity common jack section, and capable of transmitting an electrical signal via a transmission medium for the electrical signal when a plug for the electrical signal, which has a similar shape to that of the plug for the optical signal, connected to an end of the transmission medium is inserted into the light-electricity common jack section, the circuit section further including:
a signal processing circuit for the light-electricity converting element, and a shutdown circuit for blocking power to the light-electricity converting element and to the signal processing circuit in response to a shutdown signal which is externally inputted into a shutdown terminal.

14. The electric apparatus as set forth in claim 13, wherein:
the light-electricity common jack section includes a plug insertion detection means and a plug type detection means; and
an control circuit, externally connected with the optical/electrical common transmission apparatus, determines whether or not the shutdown is necessary, in response to detection results of the plug insertion detection means and the plug type detection means, and outputs the shutdown signal to the shutdown terminal when it is determined that the shutdown is necessary.

15. The electric apparatus as set forth in claim 13, wherein:
the light-electricity common jack section includes a plug insertion detection means and a plug type detection means; and
the circuit section includes an internal determination circuit for determining whether or not the shutdown is necessary in response to detection results of the plug insertion detection means and the plug type detection means, and outputting the shutdown signal to the shutdown terminal when it is determined that the shutdown is necessary.

16. The electric apparatus as set forth in claim 13, wherein:
the optical/electrical common transmission apparatus is externally connected with a control circuit for determining whether or not the shutdown is necessary in response to external key operation, and outputting the shutdown signal to the shutdown terminal when it is determined that the shutdown is necessary.

17. An optical transmission apparatus for performing optical transmission via an optical fiber, comprising (a) a circuit section having a light-electricity converting element, and (b) a jack section, into which a plug, connected to an end of the optical fiber, is inserted to enable the optical transmission apparatus to perform optical transmission, wherein:
the circuit section further includes a signal processing circuit for the light-electricity converting element, and a shutdown circuit for blocking power to the light-electricity converting element and to the signal processing circuit in response to a shutdown signal which is externally inputted into a shutdown terminal.

18. The optical transmission apparatus as set forth in claim 17, being externally connected with a control circuit for determining whether or not the shutdown is necessary in response to external key operation, and outputting the shutdown signal to the shutdown terminal when it is determined that the shutdown is necessary.

19. The optical transmission apparatus as set forth in claim 17, wherein:
the jack section includes a second metal terminal that touches, when the plug is inserted, a predetermined first metal terminal of the plug so as to detect whether or not the plug is inserted and to obtain a plug insertion detection result; and
the circuit section includes an internal determination circuit for determining whether or not the shutdown is necessary in response to the plug insertion detection result via the second metal terminal, and outputting the shutdown signal to the shutdown terminal when it is determined that the shutdown is necessary.

20. The optical transmission apparatus as set forth in claim 17, wherein:
the jack section includes, at an inserting slot thereof, a shutter and a switch, which turns ON/OFF in accordance with an open/close state of the shutter, so as to obtain a switching detection result; and
the circuit section includes an internal determination circuit for determining whether or not the shutdown is necessary in response to turning ON and OFF of the switch, and outputting the shutdown signal to the shutdown terminal when it is determined that the shutdown is necessary.

21. An electric apparatus comprising an optical transmission apparatus for performing optical transmission via an optical fiber, comprising (a) a circuit section having a light-electricity converting element, and (b) a jack section, into which a plug, connected to an end of the optical fiber, is inserted to enable the optical transmission apparatus to perform optical transmission, wherein:
the circuit section further includes a signal processing circuit for the light-electricity converting element, and a shutdown circuit for blocking power to the light-electricity converting element and the signal processing circuit in response to a shutdown signal which is externally inputted into a shutdown terminal.

22. The electric apparatus as set forth in claim 21, wherein:
the optical transmission apparatus is externally connected with a control circuit for determining whether or not the shutdown is necessary in response to external key operation, and outputting the shutdown signal to the shutdown terminal when it is determined that the shutdown is necessary.

23. The electric apparatus as set forth in claim 21, wherein:
the jack section includes a second metal terminal that touches, when the plug is inserted, a predetermined first metal terminal of the plug so as to detect whether or not the plug is inserted and to obtain a plug insertion detection result; and
the circuit section includes an internal determination circuit for determining whether or not the shutdown is necessary in response to the plug insertion detection result via the second metal terminal, and outputting the shutdown signal to the shutdown terminal when it is determined that the shutdown is necessary.

24. An electronic apparatus as set forth in claim 21, wherein:
the jack section includes, at an inserting slot thereof, a shutter and a switch, which turns ON/OFF in accordance with an open/close state of the shutter, so as to obtain a switching detection result; and
the circuit section includes an internal determination circuit for determining whether or not the shutdown is necessary in response to turning ON and OFF of the switch, and outputting the shutdown signal to the shutdown terminal when it is determined that the shutdown is necessary.
